(19) United States
(12) Patent Application Publication
(10) Pub. No.: US 2022/0057633 A1
(43) Pub. Date: Feb. 24, 2022

(54) NEAR-EYE DISPLAY SYSTEM FOR PUPIL EXPANSION BASED ON DIFFRACTIVE OPTICAL ELEMENT

(71) Applicant: Shenzhen Lochn Optics Hi-Tech Co., Ltd., Shenzhen (CN)

(72) Inventors: Qiang Song, Shenzhen (CN); Xiaoyun Tang, Shenzhen (CN); Hengshen Xu, Shenzhen (CN); Guobin Ma, Shenzhen (CN); Tao Wang, Shenzhen (CN)

(21) Appl. No.: 17/519,693

(22) Filed: Nov. 5, 2021

Related U.S. Application Data
(63) Continuation of application No. PCT/CN2020/080207, filed on Mar. 19, 2020.

(30) Foreign Application Priority Data
Sep. 24, 2019 (CN) 201910903337.6

(51) Int. Cl. G02B 27/01; G02B 26/08; G02B 27/42; G02B 27/30

(52) U.S. Cl. CPC G02B 27/0101; G02B 26/0833; G02B 2027/0192; G02B 27/30; G02B 27/4233

(57) ABSTRACT

A near-eye display system for pupil expansion based on a diffractive optical element includes: A laser light source or an LED light source; a diffusion sheet, arranged on an emergent light path of the laser light source or the LED light source; a micro-electro-mechanical system (MEMS) scanning mirror, arranged on an emergent light path of the diffusion sheet; a diffractive optical element, arranged on an emergent light path of the MEMS scanning mirror; a collimating lens module, arranged on an emergent light path of the diffractive optical element; a mirror, arranged on an emergent light path of the collimating lens module; and a reflective diffraction structure, arranged on a reflection light path of the mirror such that a human eye sees a superimposed image of a real world and a virtual world.

This application is based upon and claims priority to Chinese Patent Application No. 2019109033376, filed before China National Intellectual Property Administration on Sep. 24, 2019 and entitled “NEAR-EYE DISPLAY SYSTEM FOR PUPIL EXPANSION BASED ON DIFFRACTIVE OPTICAL ELEMENT,” the entire contents of which are incorporated herein by reference.

### TECHNICAL FIELD

The present disclosure relates to the technical field of augmented reality, and in particular, relates to a near-eye display system for pupil expansion based on a diffractive optical element.

### BACKGROUND

Augmented reality is the technology that merges virtual information with a real world. The design of a near-eye display system is critical to the augmented reality technology. How to simultaneously improve the field of view (FOV), eye box, brightness, uniformity, and contrast of the near-eye display system and reduce power consumption and volume of the system becomes a hot issue in this field.

At present, the near-eye display system generally adopts a micro display screen such as a liquid crystal display (LCD), a light emitting diode (LED) display, a digital light processing (DLP), or a liquid crystal on silicon (LCOS). These different types of micro displays have their own advantages and disadvantages, but have a common defect, that is, a limited FOV. For a greater FOV, the area of the micro display screen needs to be increased. This, however, increases volume and weight of the system. The eye box refers to a cone-shaped area between a near-eye display optical module and an eyeball, eyes can see the clearest images in this area, and the size of area needs to be at least as large as a pupil of a human eye, that is, about 4 mm. Since a relative movement may be present between the human eye and the near-eye display optical module, for a better view, it is necessary to expand the eye box, and expansion of the eye box is also referred to as pupil expansion.

At present, in a commonly used method for pupil expansion, a plurality of splitting films that are parallelly distributed are embedded in a waveguide sheet, and part of light is coupled out each time encountering the splitting films during propagation in the waveguide, and uniformity of the coupled image is ensured by adjusting reflection and transmittance rate of the splitting films at different positions, thereby achieving pupil expansion in a transversal direction. This pupil expansion relies on traditional optics, and wavelength, angle sensitivity, flatness of the bonding of the splitting film need to be precisely controlled, such that processing difficulty is great and yield of mass production is low. In addition, this solution is still defective in that only unidirectional pupil expansion is achieved. In another method for pupil expansion, three grating regions are distributed on the waveguide sheet, including a coupling-in grating, a turning grating, and a coupling-out grating. The turning grating is responsible for transversal pupil expansion and the coupling-out grating is responsible for longitudinal pupil expansion. Both the turning grating and the coupling-out grating are divided into a plurality of sub-regions. After light encounters a sub-region, part of the light is diffractively diverted or coupled out, and the rest of the light continues to be propagated along the waveguide sheet. The uniformity of the coupled image is ensured by controlling diffraction efficiency by height adjustment of the gating in each sub-regions, thereby achieving bidirectional pupil expansion. Such pupil expansion relies on diffractive optics. An area position of the grating and a height of the grating in different regions need to be precisely regulated, such that the processing difficulty and cost are extremely high. In addition, the image brightness and uniformity of the optical module based on this pupil expansion method are also low.

### SUMMARY

In one aspect, the present disclosure provides a near-eye display system for pupil expansion based on a diffractive optical element. The near-eye display system includes:

a laser light source or a light-emitting diode (LED) light source, the laser light source or the LED light source being configured to emit a light beam of a monochromatic wavelength, bi-primary color wavelengths, or tri-primary color wavelengths;

a diffusion sheet, arranged on an emergent light path of the laser light source or the LED light source, and configured to obtain a light beam of a predetermined shape by shaping and homogenizing the light beam of the monochromatic wavelength, the bi-primary color wavelengths, or the tri-primary color wavelengths;

a micro-electro-mechanical system (MEMS) scanning mirror, arranged on an emergent light path of the diffusion sheet, and configured to obtain a scanning light beam by scanning the light beam of the predetermined shape at a plurality of angles;

a diffractive optical element, arranged on an emergent light path of the MEMS scanning mirror, and configured to divide the scanning light beam into a plurality of beams of scanning light;

a collimating lens module, arranged on an emergent light path of the diffractive optical element, and configured to convert the plurality of beams of the scanning light into a plurality of beams of parallel light;

a mirror, arranged on an emergent light path of the collimating lens module, and configured to reflect the plurality of beams of parallel light; and

a reflective diffraction structure, arranged on a reflection light path of the minor, and configured to diffract a plurality of beams of reflected light to a human eye, such that the human eye sees a superimposed image of a real world and a virtual world.

The present disclosure provides a near-eye display system for pupil expansion based on a diffractive optical element. Configuration of the diffractive optical element in the system is intended to split the light, and pupil expansion may be achieved as long as one diffractive optical element is needed, such that manufacturing process is simple and system light loss is small. Imaging adopts the MEMS scanning mirror, and displaying adopts the reflective diffractive structure. The MEMS scanning mirror can expand the FOV by changing scanning angles of the scanning mirror. Optical waveguide imaging requires light to be totally reflected and propagated in the waveguide sheet. For a greater FOV, the waveguide material with a higher refractive index needs to be used. However, in the present disclosure, the diffraction imaging using the reflective diffractive structure is no longer subject to such restriction. In the present disclosure, the manufacturing process is simple, and the processing difficulty and the manufacturing cost are low. In addition, power consumption and volume of the system are reduced while improvements of FOV, eye box, brightness, uniformity, and contrast are achieved.

### BRIEF DESCRIPTION OF THE DRAWINGS

For clearer descriptions of the technical solutions according to the embodiments of the present disclosure, drawings that are to be referred for description of the embodiments are briefly described hereinafter. Apparently, the drawings described hereinafter merely illustrate some embodiments of the present disclosure. Persons of ordinary skill in the art may also derive other drawings based on the drawings described herein without any creative effort.

FIG. 1 is a schematic structural view of a near-eye display system for pupil expansion based on a diffractive optical element according to an embodiment of the present disclosure;

FIG. 2 is a schematic view of distribution of light intensity after incident light passes through a diffusion sheet;

FIG. 3 is a schematic structural view of a 9×9 dot matrix diffractive optical element;

FIG. 4 is a schematic view of an imaging dot matrix of a 9×9 dot matrix diffractive optical element; and

FIG. 5 is a schematic view of a pattern array formed by scanning imaging with 9×9 beams of light.

### DETAILED DESCRIPTION

The technical solutions contained in the embodiments of the present disclosure are described in detail clearly and completely hereinafter with reference to the accompanying drawings for the embodiments of the present disclosure. Apparently, the described embodiments are only a portion of embodiments of the present disclosure, but not all the embodiments of the present disclosure. Based on the embodiments of the present disclosure, all other embodiments derived by persons of ordinary skill in the art without any creative efforts shall fall within the protection scope of the present disclosure.

For ease of understanding of the objectives, features, and advantages of the present disclosure, the present disclosure is described in detail with reference to the attached drawings and specific embodiments.

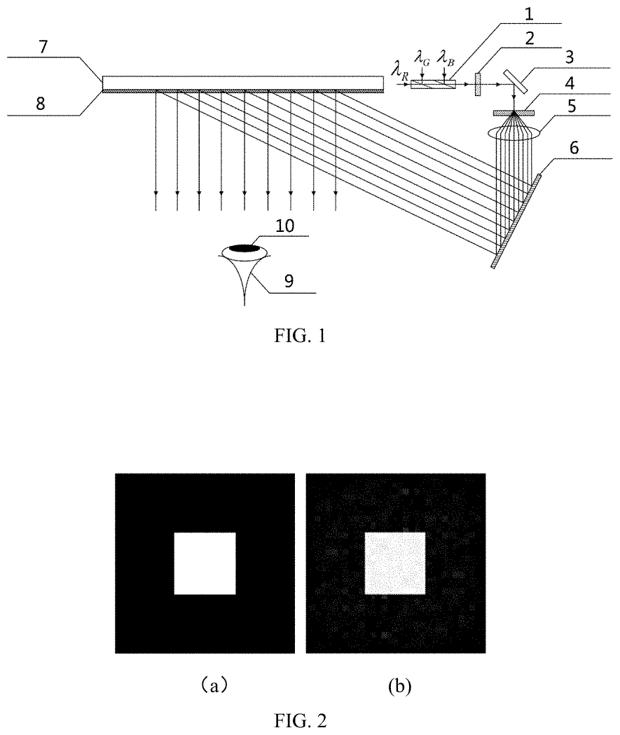

FIG. 1 is a schematic structural view of a near-eye display system for pupil expansion based on a diffractive optical element according to an embodiment of the present disclosure.

Referring to FIG. 1, the near-eye display system according to this embodiment includes: a laser light source 1, a diffraction sheet 2, a micro-electro-mechanical system (MEMS) scanning mirror 3, a diffractive optical element 4, a collimating lens module 5, a mirror 6, and a reflective diffraction structure.

The laser light source 1 is configured to emit lasers of tri-primary color wavelengths. The lasers of the tri-primary color wavelengths are lasers of red, green, and blue (RGB) tri-primary color wavelengths. The red laser has a wavelength of λ_{R}, the green laser has a wavelength of λ_{G}, and the blue laser has a wavelength of λ_{B}.

In some other embodiments, the laser light source 1 is further configured to emit a laser of a monochromatic wavelength or bi-primary color wavelengths.

In some other embodiments, the laser light source may be replaced by an LED light source, and after the laser light source is replaced by the LED light source, the LED light source is configured to emit a light beam of a monochromatic wavelength, bi-primary color wavelengths, or tri-primary color wavelengths.

The diffusion sheet 2 is arranged on an emergent light path of the laser light source 1, and configured to obtain a light beam of a predetermined shape by shaping and homogenizing the lasers of the tri-primary color wavelengths.

In some other embodiments, when the laser light source 1 emits the laser of the monochromatic wavelength or bi-primary color wavelengths, the diffusion sheet 2 is configured to obtain the light beam of the predetermined shape by shaping and homogenizing the laser of the monochromatic wavelength or the bi-primary color wavelengths.

In some other embodiments, when the laser light source is replaced by the LED light source, the diffusion sheet 2 is arranged on an emergent light path of the LED light source, and configured to obtain the light beam of the predetermined shape by shaping and homogenizing the light beam of the monochromatic wavelength, the bi-primary color wavelengths, or the tri-primary color wavelengths.

The MEMS scanning mirror 3 is arranged on an emergent light path of the diffusion sheet 2, and configured to obtain a scanning light beam by scanning the light beam of the predetermined shape at a plurality of angles. In practice, scanning of incident light at a plurality of angles is achieved by controlling biaxial movement of the MEMS scanning mirror 3.

The diffractive optical element 4 is arranged on an emergent light path of the MEMS scanning mirror 3, and configured to divide the scanning light beam into a plurality of beams of scanning light. In practice, the number and form of light beams may be changed by replacing the diffractive optical element with different structures.

The collimating lens module 5 is arranged on an emergent light path of the diffractive optical element 4, and configured to convert the plurality of beams of the scanning light into a plurality of beams of parallel light.

The mirror 6 is arranged on an emergent light path of the collimating lens module 5, and configured to reflect the plurality of beams of parallel light.

The reflective diffraction structure is arranged on a reflection light path of the mirror 6, and configured to diffract a plurality of beams of reflected light to a human eye 9, such that the human eye sees a superimposed image of a real world and a virtual world.

In an optional embodiment, the reflective diffraction structure includes a substrate 7 and a reflective diffraction layer 8 arranged on the substrate 7. The plurality of beams of parallel light are reflected to the reflective diffraction structure by using the mirror 6, and the light acts on the reflective diffraction layer 8 of the reflective diffraction structure to generate diffraction, such that diffracted light enters the human eye, and the near-eye display is implemented.

In an optional embodiment, the diffractive optical element 4 is a dot matrix diffractive optical element.

In an optional embodiment, the diffusion sheet 2 is a diffractive optical element structure or a micro lens array structure.

In an optional embodiment, the reflective diffraction layer 8 is a blazed grating or an oblique grating. In practice, diffraction efficiency and uniformity of grating are controlled by adjusting such parameters as duty, groove depth, and coating thickness of the grating.

In an optional embodiment, the reflective diffraction layer 8 is a holographic structure.

In an optional embodiment, the substrate 7 is a transparent lens.

In an optional embodiment, the MEMS scanning mirror 3 is a two-dimensional MEMS scanning mirror.

The near-eye display system for pupil expansion based on a diffractive optical element is described hereinafter using a specific example.

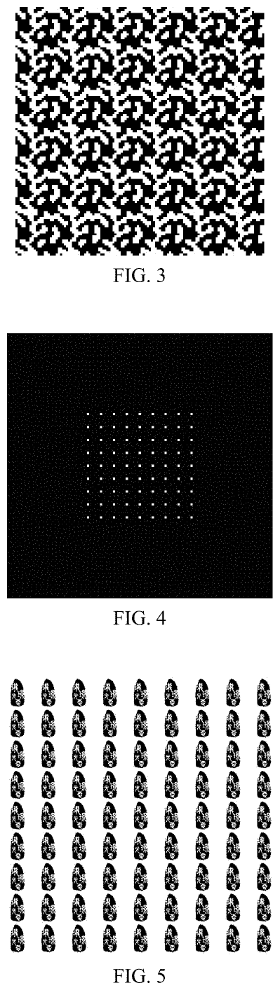

The light emitted by the laser light source sequentially passes through the diffusion sheet, the MEMS scanning mirror, a 9×9 dot matrix diffractive optical element, the collimating lens module, and the mirror, and enters the human eye in response to encountering the reflective diffraction layer in the reflective diffraction structure. The diffusion sheet is configured to shape and homogenize the light emitted by the laser light source, such that the incident light is shaped into a target shape, and distribution of light intensity in a target area is more uniform. FIG. 2 is a schematic diagram of distribution of light intensity after incident light passes through the diffusion sheet, wherein part (a) in FIG. illustrates an ideal result, and part (b) in FIG. 2 illustrates a simulation result using a diffusion sheet. The MEMS scanning mirror performs scanning imaging by changing a reflection angle of the incident light. The 9×9 dot matrix diffractive optical element converts a single beam of the incident light into 9×9 beams of light, and the collimating lens module converts the 9×9 beams of light into parallel light, the mirror reflects the incident parallel light to the reflective diffraction layer, the reflective diffraction layer diffracts the 9×9 beams of parallel light to the pupil 10 and then the light enters the human eye 9. The transparent lens is used as the substrate such that the human eye can see the superimposed image of the real world and the virtual projection. The structure of the dot matrix diffractive optical element can be designed using related software based on the scalar diffraction theory. FIG. 3 is a schematic structural diagram of a 9×9 dot matrix diffractive optical element which can convert a single beam of light into 9×9 beams of light. FIG. 4 is a schematic diagram of an imaging dot matrix of a 9×9 dot matrix diffractive optical element. FIG. 5 is a schematic view of a pattern array formed by scanning imaging with 9×9 beams of light.

In the near-eye display system for pupil expansion based on the diffractive optical element according to the embodiment, imaging adopts the MEMS scanning mirror, displaying adopts the reflective diffractive structure, and the pupil expansion is achieved by the diffractive optical element. In this way, power consumption and volume of the system are reduced while improvements of FOV, eye box, brightness, uniformity, and contrast of are implemented. Specifically:

(1) The method for pupil expansion is simple and achieves a good effect. The diffractive optical element may divide a single light beam into N×M beams of light with equal intensity, wherein N and M are both positive integers. After a beam of laser is irradiated to the diffractive optical element, a diffraction pattern of the laser is a rectangular lattice with regularly distributed, and the pattern of the rectangular lattice is adjustable. The manufacture of the diffractive optical element is easy and the diffraction efficiency is high. Therefore, bidirectional pupil expansion by using the diffractive optical element has greater advantages: The uniformity of imaging may be improved and the processing difficulty and cost may be reduced, and in addition, mass production may be achieved.

(2) The MEMS scanning mirror and the reflective diffraction structure are configured for diffractive imaging, and the FOV may be adjusted without being restricted by the refractive index of the material. Applying the MEMS scanning mirror to the imaging of the near-eye display system reduces size, weight, and power consumption of the system, and achieves higher brightness and contrast. In addition, the FOV may be enlarged by changing a scanning angle of a two-dimensional scanning mirror. Optical waveguide imaging requires the light to be totally reflected and propagated in the waveguide sheet. For a greater FOV, the waveguide material with a higher refractive index needs to be used. However, the diffraction imaging using a reflective diffractive structure is no longer subject to this restriction.

In the specification, the principles and embodiments of the present disclosure are illustrated with reference to specific exemplary embodiments or examples. However, the description of the above embodiments is merely for ease of understanding of the method and core concept of the present disclosure. In the meantime, persons of ordinary skill in the art would derive variations or modifications to the present disclosure based on the concept of the present disclosure and the specific embodiments and application scope thereof. In conclusion, the content of the specification shall not be construed as limiting the present disclosure.

What is claimed is:

1. A near-eye display system for pupil expansion based on a diffractive optical element, comprising:
a laser light source, the laser light source being configured to emit a light beam of tri-primary color wavelengths;
a diffusion sheet, arranged on an emergent light path of the laser light source, and configured to obtain a light beam of a predetermined shape by shaping and homogenizing the light beam;
a micro-electro-mechanical system (MEMS) scanning mirror, arranged on an emergent light path of the diffusion sheet, and configured to obtain a scanning light beam by scanning the light beam of the predetermined shape at a plurality of angles;
a diffractive optical element, arranged on an emergent light path of the MEMS scanning mirror, and configured to divide the scanning light beam into a plurality of beams of scanning light;
a collimating lens module, arranged on an emergent light path of the diffractive optical element, and configured to convert the plurality of beams of the scanning light into a plurality of beams of parallel light;
a mirror, arranged on an emergent light path of the collimating lens module, and configured to reflect the plurality of beams of parallel light; and
a reflective diffraction structure, arranged on a reflection light path of the mirror, and configured to diffract a plurality of beams of reflected light to a human eye, such that the human eye sees a superimposed image of a real world and a virtual world;
wherein the reflective diffraction structure comprises a substrate and a reflective diffraction layer arranged on the substrate; the reflective diffraction layer being configured to diffract the plurality of beams of reflected light;
the substrate being a transparent lens; wherein the diffractive optical element is a dot matrix diffractive optical element; wherein the diffusion sheet is a diffractive optical element structure or a micro lens array structure.

2. The near-eye display system according to claim 1, wherein the reflective diffraction layer is a blazed grating.

3. The near-eye display system according to claim 1, wherein the reflective diffraction layer is an oblique grating.

4. The near-eye display system according to claim 1, wherein the MEMS scanning mirror is a two-dimensional MEMS scanning mirror.
